(19) United States
(12) Patent Application Publication
(10) Pub. No.: US 2018/0143792 A1
(43) Pub. Date: May 24, 2018

(54) REDIRECTING A PRINT JOB

(71) Applicant: Hewlett Packard Enterprise Development LP, Houston, TX (US)

(72) Inventors: Uyen Chau, Roseville, CA (US); Tsun-Yao Chang, Roseville, CA (US)

(73) Assignee: Hewlett Packard Enterprise Development LP, Houston, TX (US)

(21) Appl. No.: 15/572,002

(22) PCT Filed: May 15, 2015
(86) PCT No.: PCT/US15/31094

§ 371 Date: Nov. 6, 2017

(51) Int. Cl. G06F 3/12

(52) U.S. Cl. CPC G06F 3/126; G06F 3/1259; G06F 3/1267; G06F 3/1292

(57) ABSTRACT

In an example, a method is disclosed for redirecting a print job. The method includes monitoring status of a plurality of printers on a network, determining that a first printer of the plurality of printers that is responsible for a print job is not suitable for processing the print job, and selecting a second printer of the plurality of printers to process the print job. The method further includes generating a flow table modification message for a network flow corresponding to the print job to redirect the network flow to the second printer and sending the flow table modification message to a network device on the network.

### BACKGROUND

Many locations, such as offices, have multiple printers available for printing in a given area. The printers can have various functionalities, and some printers may be closer than other printers. Users often have the ability to select a printer to process a particular print job. Sometimes the selected printer is out of a consumable (e.g., ink, paper), is suffering a mechanical malfunction, or is overloaded with print requests. In such cases, it can be frustrating for the user, such as if the user goes to the printer to pick up the document and then discovers that the print job has not been processed.

### BRIEF DESCRIPTION OF DRAWINGS

The following detailed description refers to the drawings, wherein:

FIG. 1a illustrates a method to redirect a print job, according to an example.

FIG. 1b illustrates a method to direct a print job from a mobile device to a printer, according to an example.

FIG. 2 illustrates a software defined network controller to redirect a print job, according to an example.

FIG. 3 illustrates a computer-readable medium to redirect a print job, according to an example.

### DETAILED DESCRIPTION

As described above, many locations, such as offices, have multiple printers available for printing in a given area. The printers can have various functionalities, and some printers may be closer than other printers. Users often have the ability to select a printer to process a particular print job. Sometimes the selected printer is out of a consumable (e.g., ink, paper), is suffering a mechanical malfunction, or is overloaded with print requests. In such cases, it can be frustrating for the user, such as if the user goes to the printer to pick up the document and then discovers that the print job has not been processed. The user may then have to spend time attempting to resolve the problem, such as by refilling the paper, adding ink, fixing a paper jam, or the like. Sometimes the user may have to return to his or her electronic device to find and select a new printer to process the print job.

According to the techniques described herein, a software defined network (SDN) interconnecting the various printers and devices in a local area network of an office may be used to intelligently redirect print jobs without input from the user or a network administrator. A printer coordination application running on the SDN controller for the network may use printer status information, printer capability information, printer location information, network status information, and the like, to determine when a printer to which a print job has been directed is not suitable for processing the print job. The printer coordination application may identify a new printer on the network that is suitable to process the print job. To make the determination, the printer coordination application may consider various criteria, such as location of the new printer, mechanical status of the new printer, consumable status of the new printer, capability information of the new printer, the number of jobs the new printer is currently processing, and network connectivity to the new printer, among other things.

In an example, a method may be provided to redirect a print job. The method can be performed by a processor, such as a processor in an SDN controller or in a computer executing an SDN application and communicating with the SDN controller. The method may include monitoring status of a plurality of printers on the network, such as consumable status, mechanical status, number of active jobs, and network connectivity to the printer. The method may include determining that a first printer of the plurality of printers that is responsible for a print job is not suitable for processing the print job. The first printer may be the printer that the user originally selected for printing. The printer may be deemed unsuitable for processing the print job for various reasons, such as inadequate consumables to complete the printer job, inoperability of the printer, excessive workload of the printer, poor network connectivity to the printer, and the like. The method may further include selecting a second printer of the plurality of printers to process the print job. The second printer may be selected based on various criteria, such as the location of the second printer (i.e., ensure that the second printer is within some vicinity of the user's location or the location of the first printer), capabilities of the second printer, status of the second printer, and the like.

The method may further include generating a flow table modification message for a network flow corresponding to the print job to redirect the network flow to the second printer, and sending the flow table modification message to a network device on the network. The flow table modification message, as explained below, may instruct the network device to update the network device's forwarding table so that a network flow corresponding to the print job is directed to the second printer instead of to the first printer. The method may also include notifying a user (who requested the print job) of the redirection of the print job to the second printer. In some examples, the notification may be effected by sending a message to the user via a user interface of the user's printing application, via another application running on the user's device, via a user interface of the first printer (i.e., so that the user receives the message when the user attempts to pick up the document at the first printer), or via an email message, among other ways. Accordingly, the print job may be redirected to a more suitable printer without intervention by a user or a network administrator, thus potentially improving user experience and satisfaction. Additional advantages, such as appropriate load balancing of print jobs among a group of printers, may also be realized as a result of the method. Additional examples, advantages, features, modifications and the like are described below with reference to the drawings.

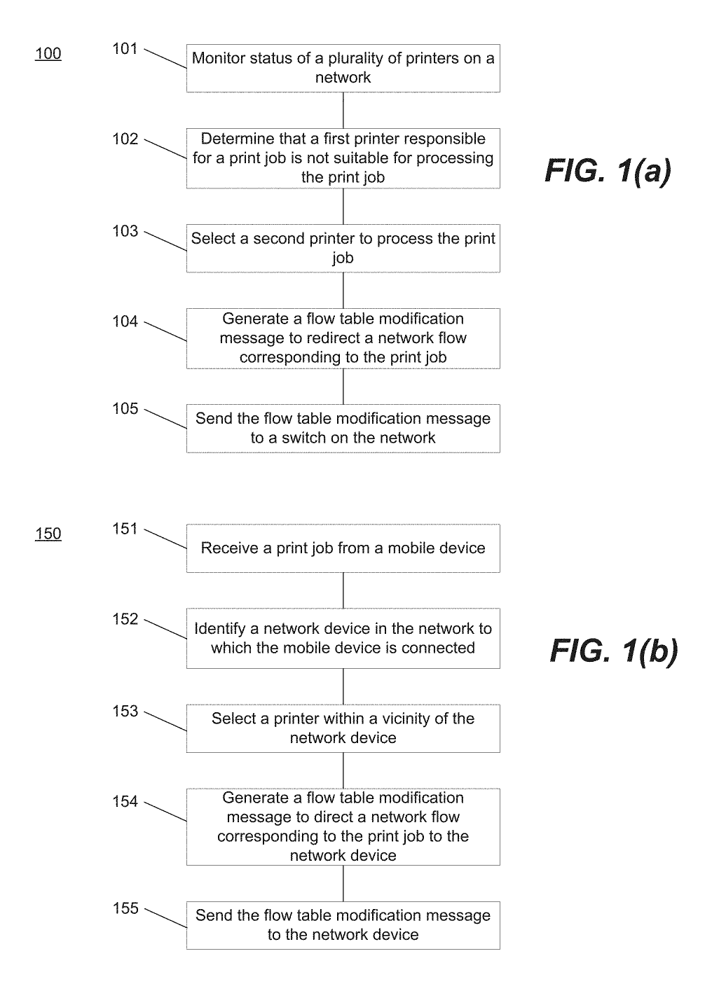

FIG. 1a illustrates a method 100 to redirect a print job, according to an example. FIG. 1b illustrates a method 150 to direct a print job from a mobile device to a printer, according to an example. Methods 100 and 150 may be performed by a computing device, system, or computer, such as controller 210 or computer 310. Computer-readable instructions for implementing methods 100 and 150 may be stored on a computer readable storage medium. These instructions as stored on the medium are referred to herein as “modules” and may be executed by a computer.

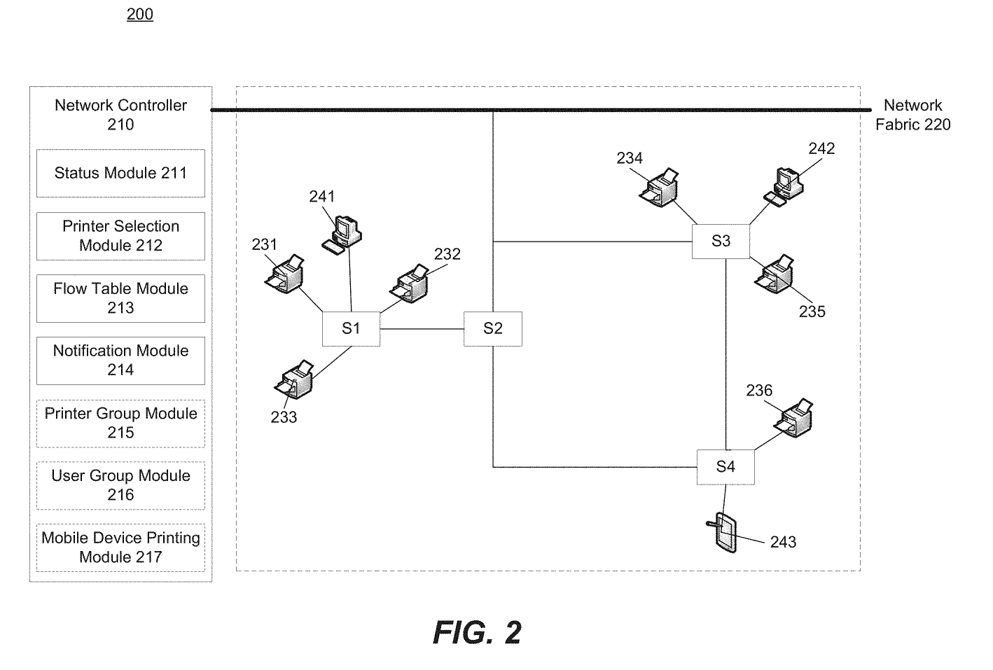

Methods 100 and 150 will be described here relative to environment 200 of FIG. 2. Environment 200 may include and/or be implemented by one or more computers. For example, the computers may be server computers, network devices such as switches, workstation computers, desktop computers, laptops, mobile devices, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory.

Environment 200 may include a number of components. For example, environment 200 may include a network controller 210, a network fabric 220 including multiple network devices, and an interconnected group of devices including printers 231-236 and user devices (e.g., desktop computers, laptops, tablets, etc.) 241-243.

Environment 200 may be interconnected via network fabric 220. Network fabric 220 may be part of a Software Defined Network (SDN) controlled by one or more network controllers 210. Network fabric 220 may include wired and wireless network devices S1-S4, such as switches, routers, bridges, wireless access points, and the like. An SDN network separates the control plane from the data plane, such that a network controller (e.g., network controller 210) can make decisions regarding where and how network traffic is to be sent while the data plane (e.g., network fabric 220) can be programmed by the network controller to forward and manipulate the traffic. There is also an application plane including one or more SDN applications whose functionality can be implemented by the network controller. In FIG. 2, the various modules 211-217 of network controller 210 represent functionality of an SDN application implemented by network controller 210. In some examples, the SDN application may be implemented on one or more computers separate from the network controller 210. These one or more computers may host the SDN application and interface with the network controller 210. Either scenario is intended to be covered when referring to a network controller, such as network controller 210.

Network controller 210 includes a status module 211 to monitor the status of printers 231-236, a printer selection module 212 to select a printer suitable for processing a print job, a flow table module 213 to generate flow table modification messages to redirect a network flow corresponding to the print job, and a notification module 214 to notify a user of the redirection of the print job. Network controller 210 may also include a printer group module 215 to organize printers 231-236 into groups, a user group module 216 to organize users into groups, and a mobile device printing module 217 to direct a print job from a mobile device to a suitable printer. Modules 211-217 represent functionality of a printer coordination SDN application implemented by network controller 210.

Network controller 210 may have other functionality for managing network fabric 220 in accordance with the SDN paradigm. An example communications protocol for implementing an SDN network is OpenFlow. Examples in this disclosure are explained with reference to an OpenFlow implementation of an SDN network. As will be appreciated by one of ordinary skill in the art, the described examples may be implemented using other SDN communications protocols.

According to an OpenFlow implementation, switches in network fabric 220 store one or more flow tables for matching and forwarding network traffic received by the switch. The traffic is in the form of packets. Multiple packets directed from one device to another device may constitute a network flow. For example, a packets related to a video stream, an audio stream, a web session, a Voice-Over-Internet-Protocol session, etc., may each constitute a separate network flow. More particularly as it relates to this application, a print job may comprise multiple packets and may constitute a network flow. Furthermore, different jobs may constitute different network flows.

The flow tables may include multiple flow table entries including various fields and corresponding information. A switch may consult the flow tables to determine how to handle a particular network flow it is receiving. A flow table entry may include match fields and instructions, as well as other fields not discussed here. The match fields are used to determine whether a received packet (of a network flow) matches the flow table entry. For example, as used here, the match fields include the destination node for the packet. The instructions may be instructions to modify an action set or pipeline processing for the packet. In brief, the action set is the set of actions that will be applied to the packet, such as modifying a destination address of the packet or adding a flag to the packet. The pipeline processing refers to further processing through other flow tables stored in the switch. The flow table entry may have other fields and information, consistent with OpenFlow.

Flow table entries in a switch can be created or modified using flow table modification messages (sometimes referred to as “flowmods”). The flow table modification messages may be sent to the switch from the network controller, thus enabling the network controller to program the network fabric 220 to handle network traffic in particular ways. Upon receiving a flow table modification message, a network device S1-S4 updates its flow table(s) to include a corresponding flow table entry. In some cases a new flow table entry is created based on the flowmod. In other cases, an existing flow table entry is modified based on the flowmod.

Method 100 may be used to redirect a print job in a network, such as an SDN network, according to an example. Method 100 may be executed by network controller 210. In particular, for example, method 100 may be executed by an application executed by network controller 210, such as a printer coordination application.

Method 100 may begin at 101, where the status of a plurality of printers on a network may be monitored. For example, status module 211 may monitor the status of printers 231-236. Status module 211 may monitor the status of the printers by receiving periodic status updates from printers 231-236 or from a computer program external to printers 231-236 that is responsible for tracking the status of the printers. The status may include various information, such as consumable status (e.g., amount of ink and/or paper remaining), mechanical status (e.g., whether there is a mechanical issue with the printer that may prevent it from performing a print job, such as a paper jam or a particular function that is not currently working), printer job status (e.g., the number of jobs being processed by the printer), and network connectivity status (whether the network connection to the printer is up, overloaded, etc.).

At 102, method 100 may determine that a first printer responsible for a print job is not suitable for processing the print job. The first printer may be determined to be unsuitable for processing the print job for various reasons related to the printer's status. For example, assume that a user of computer 241 has sent a print job to printer 231. Network controller 210 (e.g., via status module 211) may determine that printer 231 is not suitable for processing the print job based on printer 231's status information. For instance, printer 231 may not have enough ink or paper to process the print job to completion.

At 103, method 100 may select a second printer to process the print job. The printer may be selected based on various criteria, such as the location of the printer, the capabilities of the printer, and the status of the printer. For example, printer selection module 212 may select one of printers 232-236 to process the print job originally directed to printer 231. In selecting one of printers 232-236, the printer selection module 212 may consider whether any of the printers are in the vicinity of the user's computer 241 or the originally selected printer 231. In this case, printers 232 and 233 may be deemed to be in the vicinity of both the user's computer 241 and printer 231. Conversely, printers 234, 235, and 236 may be deemed to not be in the vicinity of user computer 241 or original printer 231. The location of the printers and user computers may be stored in a table to enable an analysis of how close the devices are to each other (e.g., whether they are within a certain threshold distance) or may be deduced based on the network device (e.g., S1-S4) to which they are connected. Alternatively, the printers may be grouped together in multiple based on various criteria, such as location. In such a case, printer selection module 212 may need only select a replacement printer from the same group to ensure that the replacement printer is within a suitable vicinity. Other criteria that may be considered by printer selection module 212 are status information of the printers (e.g., which printers are currently capable of processing the print job to completion) and capability information of the printers (e.g., black-and-white, color, duplex, stapling, collating, etc.). The capability information of the printers may also be a basis by which the printers are grouped together in a particular group. In any event, printer selection module 212 may select a new printer to handle the print job. For purposes of the example use case, assume that printer 232 has been selected as the new printer.

At 104, method 100 may generate a flow table modification message to cause a network flow corresponding to the print job to be redirected to the second printer. For example, flow table module 213 may generate a flow table modification message to cause packets corresponding to the print job to be redirected by the network to printer 232. To accomplish this, the flow table modification message may instruct the network device that receives the message to modify its flow table entries (or create a new entry with higher priority than an existing entry) such that when a packet having a destination address of original printer 231 is received, the network device overwrites the destination address to be the destination address of the replacement printer—printer 232. Modifying the destination address of the packets in such a manner will result in network device S1 forwarding those packets to printer 232 instead of to printer 231.

At 105, method 100 may send the generated flow table modification message to a switch on the network. For example, network controller 210 (e.g., via flow table module 213) may send the flow table modification message to network device S. The determination of which network devices to send the flow table modification message to can be made by network controller 210 based on its knowledge of the network topology. Network controller 210 can properly determine which network device(s) should receive the message and update its forwarding table in order to effectuate the intended change in forwarding. In this case, since network device S1 is the network device that will receive traffic from user computer 241 and forward it to printers 231 and 232, the message may be sent to network device S1. After network device S1 updates its flow table in accordance with the flow table modification message, the print job will be routed to printer 232 instead of to printer 231. Thus, the print job has been rerouted without user or administrator intervention and without requiring computer 241 (the user's computer) to send a new print request directed to printer 232.

Network controller 210's notification module 214 may notify a user of the redirection of the print job. Since the redirection is accomplished without user intervention, some kind of notification is useful to alert the user to go to printer 232 instead of printer 231 to pick up the printed document. Notification module 214 may notify the user in various ways. For example, notification module 214 may send a message to printer 231 to be displayed on the printer's user interface. The message can inform the user of the redirection of the print job to printer 232. As another example, notification module 214 may send a message to the user's computer 241. The message may cause computer 241 to display a message to the user (e.g., via a printing application installed on the computer or in the form of a system prompt). As a further example, the user may be notified via an email message or text message, such as in the case where a cloud printing service (e.g., Hewlett-Packard Company's® ePrint service) is associated with the user and the printers 231-236. In another example, if a suitable replacement printer is unavailable (such as due to no available printer having the same features as the first printer required to process the print job or due to no suitable replacement printers being in the vicinity), the notification module may provide the user with an option to select a different printer to process the print job.

As mentioned previously, in some examples the printers may be grouped into multiple groups based on one or more criteria. For example, printer group module 215 may group the printers based on various criteria, such as location, printer capabilities (e.g., black-and-white, color, duplex, stapling, collating), and the like. The printer groups may facilitate the selection of replacement printers by printer selection module 212, such that a replacement printer can be selected from the same group as the original printer is a member of.

Similarly, in some examples users may be grouped into multiple groups based on one or more criteria. For example, user group module 216 may group users based on various criteria, such as location, role, and access privilege. User groups may be used in a variety of ways. For instance, they can be used to ensure access of users to their assigned printer groups. This can be effectuated through flow table modification messages that add flow entries to the network devices such that print jobs from certain user groups can only be sent to printers from certain printer groups, for example. Where a print job violates the rule, the network flow can be redirected to a printer from the appropriate group. Other uses include restricting access to printers, or to certain kinds of printers (e.g., large-format printers), to work hours. Additionally, various levels of quality-of-service may be provided depending on the user associated with the print job. For example, a print job associated with a CEO of the company may be given the highest level of priority. These use-cases and others all may be effectuated with the use of flow table modification messages to change how the network treats certain network flows.

FIG. 1b illustrates a method to direct a print job from a mobile device to a printer, according to an example. Method 150 may begin at 151, where a print job may be received from a mobile device. For example, mobile device 243 (e.g., a tablet computer) may send a print job without specifying a printer to process the print job. Network device S4 receives the print job (e.g., one or more packets in the network flow constituting the print job) and forwards details of the print job and/or packets from the network flow to network controller 210. Network controller 210 may pass this information to mobile device printing module 217.

At 152, method 150 may identify a network device to which the mobile device is connected. For example, mobile device printing module 217 may identify network device S4. At 153, method 150 may select a printer within a vicinity of the network device, For example, mobile device printing module 217 may request that printer selection module 212 select a printer within the vicinity of network device S4. Printer selection module 212 may select printer 236, since printer 236 is connected to (and thus within the vicinity of) network device S4.

At 154, method 150 may generate a flow table modification message to direct a network flow corresponding to the print job to the selected printer. For example, mobile device printing module 217 may cause flow table module 213 to generate a flow table modification message to direct a network flow corresponding to the print job to printer 236. For example, the flow table modification message may instruct that a flow entry be created that will match to packets in the network flow and cause the IP address of printer 236 to be added as the destination address in the packets. At 155, method 150 may send the flow table modification message to the network device. For example, mobile device printing module 217 may cause network controller 210 to send the generated flow table modification message to network device S4. As a result, the print job from mobile device 243 may be sent to printer 236 without the user having selected the printer. The user may be notified of the printer's identity, as described above, so that the user can pick up his/her printed document.

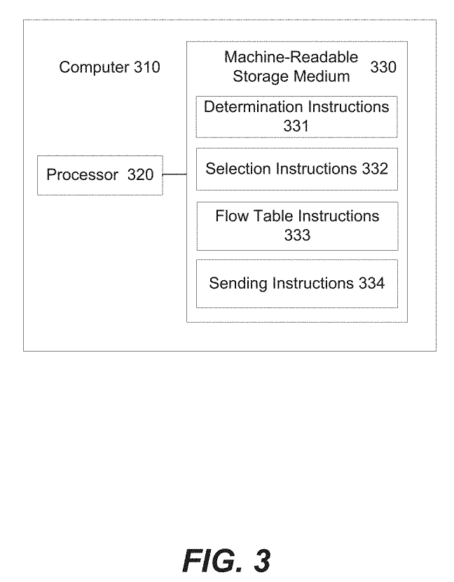

FIG. 3 illustrates a computer-readable medium to redirect a print job, according to an example. Computer 310 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to environment 200, for example.

Computer 310 may perform methods 100 and 150, and variations thereof. Additionally, the functionality implemented by computer 310 may be part of a larger software platform, system, application, or the like. For example, computer 310 may be part of an SDN network and may implement a network controller for the SDN network, such as network controller 210. Alternatively, computer 310 may be separate from the network controller and may merely host an SDN application that interfaces with the network controller.

Processor 320 may be at least one central processing unit (CPU), at least one semiconductor-based microprocessor, other hardware devices or processing elements suitable to retrieve and execute instructions stored in machine-readable storage medium 330, or combinations thereof. Processor 320 can include single or multiple cores on a chip, multiple cores across multiple chips, multiple cores across multiple devices, or combinations thereof. Processor 320 may fetch, decode, and execute instructions 331-334 among others, to implement various processing. As an alternative or in addition to retrieving and executing instructions, processor 320 may include at least one integrated circuit (IC), other control logic, other electronic circuits, or combinations thereof that include a number of electronic components for performing the functionality of instructions 331-334. Accordingly, processor 320 may be implemented across multiple processing units and instructions 331-334 may be implemented by different processing units in different areas of computer 310.

Machine-readable storage medium 330 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 330 can be computer-readable and non-transitory. Machine-readable storage medium 330 may be encoded with a series of executable instructions for managing processing elements.

The instructions 331-334 when executed by processor 320 (e.g., via one processing element or multiple processing elements of the processor) can cause processor 320 to perform processes, for example, methods 100 and 150, and/or variations and portions thereof.

For example, determination instructions may cause processor 320 to determine that a first printer responsible for a print job is unable to process the print job. Selection instructions 332 may cause processor 320 to select a second printer to process the print job. Flow table instructions 333 may cause processor 320 to generate a flow table modification message to redirect a network flow corresponding to the print job from the first printer to the second printer. Sending instructions 334 may cause processor 320 to send the flow table modification message to a network device on the network.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method for redirecting a print job, comprising, by a processor:
monitoring status of a plurality of printers on a network;
determining that a first printer of the plurality of printers that is responsible for a print job is not suitable for processing the print job;
selecting a second printer of the plurality of printers to process the print job;
generating a flow table modification message to redirect a network flow corresponding to the print job to the second printer; and
sending the flow table modification message to a network device on the network.

2. The method of claim 1, wherein monitoring status of a plurality of printers on the network comprises receiving updates regarding status of each of the plurality of printers.

3. The method of claim 2, wherein the updates regarding status comprise at least one of consumable status, mechanical status, and availability of the printer.

4. The method of claim 2, wherein the updates regarding status are received from the printers or from a program external to the printers that is responsible for monitoring status of the printers.

5. The method of claim 1, wherein determining that a first printer that is responsible for a print job is not an ideal candidate for processing the print job comprises determining that the first printer is currently incapable of processing the print job to completion.

6. The method of claim 1, wherein identifying a second printer of the plurality of printers to process the print job comprises determining that the second printer is able to process the print job better than the first printer.

7. The method of claim 6, wherein the second printer is only selected if the second printer is within a vicinity of the first printer.

8. The method of claim 6, wherein the user is notified if a second printer with the same features as the first printer is unavailable and is provided with an option of printers with similar features to choose from.

9. The method of claim 6, wherein the second printer is only selected if the second printer is a member of a same printer group as the first printer, wherein printers are grouped into printer group based on at least one of location and printer features.

10. The method of claim 6, wherein the second printer is selected in part based on an identity of a user that requested the print job.

11. The method of claim 1, further comprising:
notifying a user that requested the print job of the redirection of the print job to the second printer.

12. A controller for a software defined network, comprising:
a status module to monitor status of multiple printers on the software defined network;
a printer selection module to select a second printer to process a print job originally directed to a first printer;
a flow table module to generate a flow table modification message for a network flow corresponding to the print job to redirect the network flow to the second printer; and
a notification module to notify a user that requested the print job of the redirection of the print job to the second printer.

13. The controller of claim 12, further comprising a printer group module to group printers into multiple groups based on at least one of location and printer features, wherein the printer selection module is to select the second printer from a same group as the first printer.

14. The controller of claim 12, further comprising a user group module to group users into multiple groups based on at least one of location, role, and access privilege.

15. The controller of claim 12, further comprising:
a mobile device printing module to:
receive a print job from a mobile device;
identify a network device in the software defined network to which the mobile device is connected;
instruct the printer selection module to select a printer within a vicinity of the network device that is capable of processing the print job from the mobile device;
instruct the flow table module to generate a flow table modification message to direct a network flow corresponding to the print job from the mobile device to the selected printer; and
send the flow table modification message to direct the network flow corresponding to the print job from the mobile device to the identified network device.

16. A non-transitory computer-readable storage medium storing instructions that, when executed by a processor, cause the processor to:
determine that a first printer responsible for a print job is unable to process the print job;
select a second printer to process the print job;
generate a flow table modification message to redirect a network flow corresponding to the print job from the first printer to the second printer; and
send the flow table modification message to a network device on the network.
